(19) United States
(12) Patent Application Publication
(10) Pub. No.: US 2002/0085967 A1
(43) Pub. Date: Jul. 4, 2002

(54) Process for generating hydrogen and apparatus for generating hydrogen

(75) Inventor: Koji Yokota, Aichi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOYOTA CHUO KENKYUSHO, Aichi-gun (JP)

(21) Appl. No.: 10/011,750

(22) Filed: Dec. 11, 2001

(30) Foreign Application Priority Data
Dec. 18, 2000 (JP) 2000-383830

(51) Int. Cl. C01B 3/26

(52) U.S. Cl. 422/198; 423/652; 422/211; 422/194; 422/190; 422/109; 48/61; 48/76

(57) ABSTRACT

A contacting step, in which a mixture gas, including a fuel and steam, is contacted with a reactor bed, including a reforming catalyst and a carbon dioxide adsorbent, thereby converting the mixture gas into hydrogen and adsorbing co-generating carbon dioxide onto the carbon dioxide adsorbent, and a heating step, in which the reactor bed is heated, thereby desorbing the adsorbed carbon dioxide from the carbon dioxide adsorbent and regenerating a carbon dioxide adsorption capacity thereof, are carried out alternately. The resulting CO is converted into H₂ and CO₂, and the converted CO₂ is absorbed by the carbon dioxide adsorbent and is adsorbed outside the equilibrium system. Accordingly, methane is inhibited from co-generating. Hence, the reformed fuel gas is mostly composed of H₂ and is free from methane, and the reaction temperature limitation, i.e., from 700 to 900° C., in the steam reforming reaction is not applicable any more.

### BACKGROUND OF THE INVENTION

1. Field of the Invention

The present invention relates to a process for generating hydrogen and an apparatus for generating hydrogen, process and apparatus which can sharply reduce an amount of co-generating carbon monoxide (CO). The hydrogen, which is generated in accordance with the present invention, can be appropriately used as a raw material for synthesizing ammonia, for an automotive fuel cell, or the like.

2. Description of the Related Art

As a conventional process for generating hydrogen, a process has been known in which a steam reforming reaction is utilized. In the steam reforming reaction, hydrocarbons, such as petroleum, and steam are reacted. Since the steam reforming reaction is an equilibrium reaction, the higher the reaction temperature is, or the lower the steam concentration is, the lower the hydrogen generation ratio. On the other hand, the lower the reaction temperature is, the higher the methane generation ratio.

The aforementioned principle will be described with reference to a steam reforming reaction of octane, for example. The steam reforming reaction of octane can be considered being divided into the following three reactions.

C₈H₁₈+8H₂O→8CO+17H₂ (1)

CO+H₂O⇄CO₂+H₂ (2)

CO+3H₂⇄CH₄+H₂O (3)

The reactions set forth in equations (2) and (3) are an equilibrium reaction, and are an exothermic reaction, respectively, which proceeds in the right direction when the reaction temperature is low. Namely, when the reaction temperature is low, if only the reaction set forth in equation (2) should occur, the generation of hydrogen increases. In actuality, however, the resulting hydrogen is simultaneously consumed in an amount of 3 times by mol of CO by the reaction set forth in equation (3). As a result, methane is mainly generated. On the other hand, when the reaction temperature is high, the reactions set forth in equations (2) and (3) proceed in the left direction, the generation of CO increases. Namely, even if the reaction temperature is adjusted to any temperature, either methane or CO is generated. Thus, there exists no reaction temperature at which both of methane and CO are not generated.

Hence, the steam reforming reaction has been conventionally carried out at a temperature of 700 C or more at which methane is hardly generated. Thereafter, while controlling the reaction set forth in equation (3), CO has been converted into hydrogen by the CO shift reaction set forth in equation (2). Since the reduction of the CO concentration and the increment of the H₂ concentration can be achieved simultaneously by the CO shift reaction, it is an especially preferable method for fuel cells.

The CO shift reaction is, however, an equilibrium reaction. Accordingly, the higher the steam concentration is, the higher the CO concentration is or the lower the reaction temperature is, the more the reaction proceeds in the right direction. However, when the reaction temperature is too low, the reaction rate decreases. Moreover, the increment of the steam concentration results in a large energy loss, because it is necessary to supply a thermal energy required for vaporizing the water. Therefore, in actual applications, the molar H₂O/CO ratio is adjusted to fall in a range of from 2 to 3 approximately and the reaction temperature is controlled to fall in a range of from 200 to 300° C. approximately in general.

Moreover, the CO shift reaction is usually slow. In addition, the lower the reaction temperature is, the slower the CO shift reaction is. Consequently, in view of the balance between the reaction temperature and the volume of a catalyst to be used, the level of the reducible CO concentration is determined.

As for a catalyst which facilitates the CO shift reaction, for example, Cu—Zn-based catalysts were put into markets by Girdler Co., Ltd. and du Pont Co., Ltd. in 1960's, and have been utilized widely so far mainly for applications in plants in production industries. Moreover, in W. Hongli et al., China-Jpn.-U.S. Symp. Hetero. Catal. Relat. Energy Probl., B09C, 213 (1982), there is reported a catalyst which exhibits a much higher CO shift reactivity. The catalyst is prepared by processing a catalyst, in which Pt is loaded on a support being composed of an anatase type titania, by reduction at around 500° C.

Moreover, Japanese Unexamined Patent Publication (KOKAI) No. 11-130,405 discloses a CO shift reaction catalyst. The catalyst comprises a support, being composed of at least one member selected from the group consisting of Al₂O₃, SiO₂, TiO₂, ZrO₂ and MgO, and at least one noble metal, being selected from the group consisting of Pt, Pd and Rh and being loaded on the support. In addition, in order to control the heat, resulting from the CO shift reaction, within a predetermined range, the publication discloses a heater unit which can supply electricity to the catalyst to heat it.

However, even when the CO shift reaction is carried out by using the above-described conventional catalysts, CO remains in an amount of 0.5% by volume more or less in the resulting hydrogen. Moreover, CO₂ is also involved as a by-product therein. CO₂ can be readily removed by pressurizing, for example, so that water, or like, absorbs it. In the removal of CO, however, no such means is available. In particular, in an electrode of fuel cells, CO causes poisoning. For instance, when a reformed fuel gas, which contains CO, contacts with the electrode of fuel cells, the battery performance is degraded by the CO poisoning. Accordingly, it is required to control the CO concentration so that it is 100 ppm by volume or less, preferably 10 ppm by volume or less, in the reformed fuel gas.

Hence, as for the method for reducing the CO concentration, it is possible to think of the following means, for example, utilizing a hydrogen selective permeation film, methanizing CO, and the like. When the temperature control, etc., are taken into consideration altogether, such means, however, are complicated and large-sized, and are accordingly expensive. Therefore, such means do not conform to a small-sized purpose like a fuel cell, which utilizes a public utility gas, for cogeneration.

Therefore, in order to lower the CO concentration level, a methanization reaction set forth in equation (4), a CO selective oxidation reaction set forth in equation (5), or the like, has been utilized.

CO+3H₂→CH₄+H₂O (4)

CO+1/2O₂→CO₂ (5)

Since the reaction set forth in equation (4) is accompanied with the unnecessary H₂ consumption, it is not a preferable reaction for generating a large volume of H₂.

Moreover, when the CO is oxidized selectively by utilizing the reaction set forth in equation (5) after the CO shift reaction, it is necessary to precisely detect the CO concentration in the reformed fuel gas after the CO shift reaction, and to supply oxygen in an adequate amount for the reaction. The reason is as follows. When the oxygen amount is less than the adequate amount, the harmful CO is supplied to an electrode of a fuel cell together with the reformed fuel so that the battery performance is degraded by the CO poisoning in the electrode. On the other hand, when the oxygen amount is more than the adequate amount, even H₂, contained in the reformed fuel gas, is consumed as well by the excessive oxygen so that the H₂ amount, to be supplied to the fuel cell, becomes less.

At present, however, since no sensor, which can precisely detect the CO concentration in the reformed fuel gas, has been developed yet, the amount of oxygen to be supplied is determined based on the CO concentration, which has been measured in advance, so far. By such a method, however, it is not possible to detect the variations of the CO concentration in the reformed fuel gas in proportion to the degraded states of the reforming catalyst, and accordingly it is difficult to vary the oxygen amount so as to respond to the variation of the CO concentration. In the method, since the oxygen amount is adjusted excessively to oxidize CO so that the CO poisoning in the electrode of the fuel cell is suppressed more preferentially, it is inevitable to uselessly consume H₂ by the excessive oxygen.

In the conventional hydrogen generation process, the steam reforming reaction is carried out at a high temperature falling in a range of from 700 to 900° C., and the CO shift reaction is carried out at a temperature falling in a range of from 200 to 400° C. Consequently, in order to carry out the reactions set forth in equations (1) through (3) as well as the reaction set forth in equation (4) or (5), it is required to use a multi-stage, for example, 3-stage or more, reactor. Further, it is necessary to use both of a high temperature type catalyst, e.g., an Fe—Cr-based catalyst, and a low temperature type catalyst, e.g., a Cu—Zn-based catalyst. Furthermore, it is needed to finely control the respective reaction conditions. Accordingly, the multi-stage hydrogen generation process does not comply with the purpose of downsizing a fuel cell for boarding on automobiles, for instance, or the purpose of responding to the variation of the demanded hydrogen amount.

Moreover, in the steam reforming reaction of the conventional hydrogen generation process, it takes time to increase the reaction temperature so as to fall in the range of from 700 to 900° C. In the meantime, it is difficult to generate hydrogen. Therefore, the conventional hydrogen generation process is not appropriate for an automotive fuel cell, for example.

In addition, when the conventional reforming catalysts are used at a high temperature falling in the range of from 700 to 900° C., since the reactions of the conventional hydrogen generation process proceed in such a temperature region so fast enough that they reach the chemical equilibrium, it is impossible for the conventional reforming catalysts to reduce CO as illustrated in FIG. 7, for instance. Therefore, it is considered difficult to carry out the steam reforming reaction and the CO shift reaction in a single reactor under the identical temperature environment.

### SUMMARY OF THE INVENTION

The present invention has been developed in view of the aforementioned circumstances. It is therefore an object of the present invention to make it possible to generate hydrogen in a single reactor in a lower temperature range and to reduce a CO concentration in a reformed fuel gas so as to preferably be 100 ppm by volume or less, more preferably be 10 ppm by volume or less.

The present invention can achieve the aforementioned object. A process for generating hydrogen according to the present invention is characterized in that it comprises the steps of: contacting a mixture gas, comprising a fuel and steam, the fuel including a carbon compound at least, with a reactor bed, comprising a reforming catalyst and a carbon dioxide adsorbent, thereby converting the mixture gas into hydrogen and adsorbing co-generating carbon dioxide onto the carbon dioxide adsorbent; and heating the reactor bed, thereby desorbing the adsorbed carbon dioxide from the carbon dioxide adsorbent and regenerating a carbon dioxide adsorption capacity of the carbon dioxide adsorbent.

The heating step can preferably be carried out by directing heating the reactor bed. The heating step can further preferably be carried out by heating with a high temperature gas. The high temperature gas can preferably be prepared by completely combusting a combustion gas in which at least the fuel and oxygen are mixed. Further, the heating step can preferably be carried out by rapidly heating by means of electromagnetism. Furthermore, in the heating step, it is preferable to use the high temperature gas, which is prepared by combusting the combustion gas by means of a catalytic reaction in the reactor bed.

When the fuel includes an organic compound, such as hydrocarbon and alcohol, the reforming catalyst can preferably include at least one member selected from the group consisting of Rh and Ru. When the fuel includes CO, the reforming catalyst can preferably include at least one member selected from the group consisting of Pt and Pd, and more preferably include Pt. While, the carbon dioxide adsorbent can preferably include at least one member selected from the group consisting of alkali metals and alkaline-earth metals. Then, it is preferred that, in the reactor bed, the reforming catalyst and the carbon dioxide adsorbent are uniformly dispersed and mixed at a level of 30 nm or less.

Moreover, an apparatus for generating hydrogen according to the present invention is characterized in that it comprises: a reactor bed including a reforming catalyst and a carbon dioxide adsorbent; source gas supplying means for supplying a mixture gas, comprising a fuel and steam, the fuel including a carbon compound at least, to the reactor bed; heating means for heating the reactor bed; and temperature controlling means for controlling temperatures of the reactor bed in a contacting step and a heating step, respectively, while carrying out the contacting step, in which the mixture gas is contacted with the reactor bed, thereby converting the mixture gas into hydrogen by means of a steam reforming reaction with the reforming catalyst and adsorbing co-generating carbon dioxide onto the carbon dioxide adsorbent, and the heating step, in which the reactor bed is heated, thereby desorbing the adsorbed carbon dioxide from the carbon dioxide adsorbent and regenerating a carbon dioxide adsorption capacity of the carbon dioxide adsorbent.

In addition, the present apparatus can preferably further comprise combustion gas supplying means for supplying a combustion gas, comprising the fuel and oxygen, to the reactor bed, and switching means for alternately switching the supplies from the source gas supplying means and the combustion gas supplying means, wherein the heating means heats the reactor bed by combusting the combustion gas.

Thus, in accordance with the present hydrogen gas generation process and the present hydrogen gas generation apparatus, it is possible to carry out the contacting step and the heating step in one reactor. Besides, it is possible to carry out the hydrogen generation reaction at a lower temperature of 300 to 700° C. than the temperature at which it has been carried out conventionally. Therefore, it is possible to inhibit the reforming catalyst from degrading. Hence, it is possible to remarkably upgrade the degree of freedom in the selection of the reforming catalyst.

Then, in the resulting reformed fuel gas, CO and methane hardly exist. Hence, the resulting reformed fuel gas virtually makes 100% by volume of hydrogen, and accordingly is extremely useful as a fuel for fuel cells. Moreover, the reactor can be an independent and compact one, and consequently is an optimum one for the application in automotive fuel cells.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure:

FIG. 1 is a conceptual diagram for illustrating operations of the present invention;

FIG. 2 is a block diagram for illustrating an apparatus for generating hydrogen, which is used in examples according to the present invention;

FIG. 3 is a graph for illustrating relationships between reaction temperatures and remaining HC ratios, which were exhibited by Example No. 1 according to the present invention and Comparative Example No. 1;

FIG. 4 is a timing chart for illustrating a hydrogen generation process of Example No. 2 according to the present invention;

FIG. 5 is a timing chart for illustrating CO concentrations and CO₂ concentrations in reformed fuels, which were prepared by the hydrogen generation process of Example No. 2 as well as that of Comparative Example No. 2;

FIG. 6 is a timing chart for illustrating a hydrogen generation process of Example No. 3 according to the present invention; and

FIG. 7 is a graph for illustrating concentrations of respective gaseous species and partial pressures thereof, gaseous species which were generated after subjecting octane (C₃H₁₈) to a reforming reaction at respective reaction temperatures.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

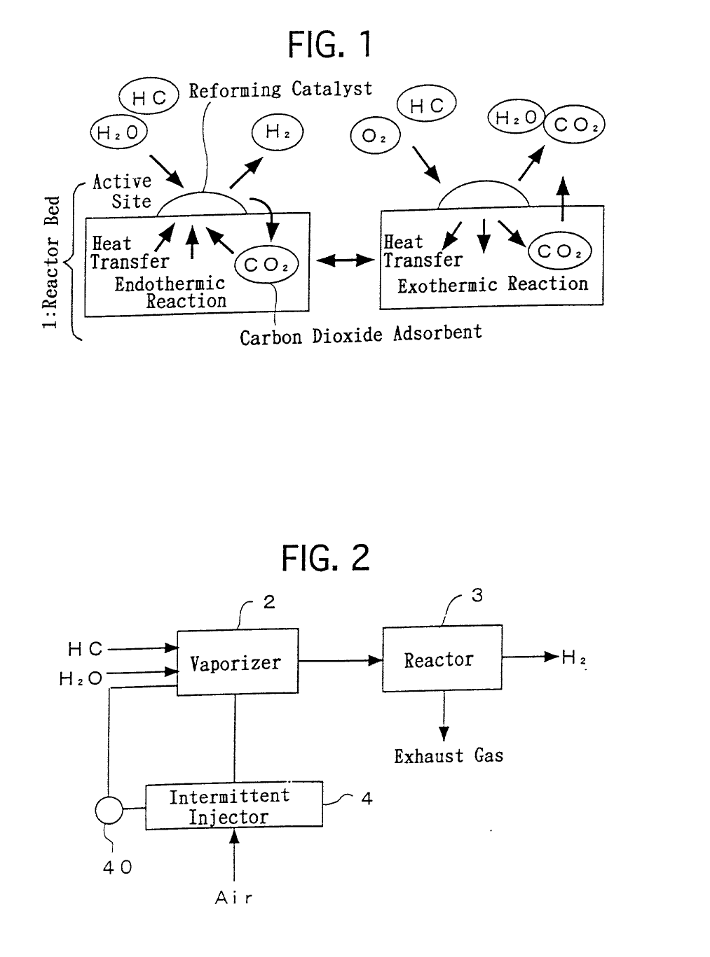

FIG. 1 illustrates a conceptual diagram of an example of a hydrogen generation process according to the present invention.

In the present generation process, a mixture gas, which comprises hydrocarbon (HC) and steam (H₂O), is first contacted with a reactor bed 1, which comprises a reforming catalyst and a carbon dioxide adsorbent, in the contacting step. In the contacting step, reactions, set forth in equations (1) through (3), take place. Then, co-generating carbon dioxide is adsorbed onto the carbon dioxide adsorbent, which is included in the reactor bed 1, simultaneously with the generation.

For instance, when octane is used as an organic compound, the equations (1) through (3) can be approximately rewritten as set forth in equation (6) at 800° C.

C₈H₈+16H₂O→18.88H₂+6.05H₂O+5.91CO+2.05CO₂+0.04CH₄ (6)

However, when an oxide (MOₓ), for example, calcium oxide, or the like, is included as the carbon dioxide adsorbent in the reactor bed 1, equation (6) can be rewritten as set forth in equation (7). Accordingly, the carbon dioxide is adsorbed outside the equilibrium system.

C₈H₁₈+16H₂O+8/xMOₓ→25H₂+8M_{1/x}CO₃ (7)

The reason why the reaction set forth in equation (7) occurs has not been clear yet. However, the reaction set forth in equation (7) takes place at a lower temperature than the reaction set forth in equation (6). Namely, in the contacting step, since the co-generating CO₂is quickly adsorbed by the carbon dioxide adsorbent, and is thereby removed. Accordingly, the reaction set forth in equation (2) proceeds in the right direction. As a result, the CO concentration decreases. When the CO concentration decreases, the reaction set forth in equation (3) proceeds in the left direction, and accordingly the methane concentration decreases as well. As a whole, the mixture gas, which passes through the reactor bed 1, generates virtually 100% by volume of H₂ and excess H₂O.

In other words, in the contacting step, since no methane generates, the limitation on the reaction temperature (e.g., from 700 to 900° C. or more) is relieved. Accordingly, the contacting step is less dependent on the reaction temperature. Moreover, since it is possible to practically use a reaction temperature of 700° C. or less, the reforming catalyst is inhibited from degrading and the degree of freedom in the selection of the reforming catalyst is upgraded that the hydrogen converting performance can be remarkably enhanced. As a result, it is possible to make a reaction temperature range of from 300 to 600° C. practical.

However, the carbon dioxide adsorbent cannot infinitely adsorb the carbon dioxide. Accordingly, when the adsorption saturates, it is difficult for the carbon dioxide adsorbent to thereafter adsorb carbon dioxide. Hence, in the present invention, the heating step is carried out in which the reactor bed 1 is heated to heat the carbon dioxide adsorbent. Consequently, the adsorbed carbon dioxide is desorbed from the carbon dioxide adsorbent, and thereby a carbon dioxide adsorption capacity of the carbon dioxide adsorbent is regenerated.

Namely, the carbonate formed by adsorbing the carbon dioxide is decomposed as set forth in equation (8). The carbon dioxide adsorbent releases carbon dioxide to convert itself back into the oxide form, and, at the same time, recovers the carbon dioxide adsorption capacity.

M_{1/x}CO₃+Heat→MOₓ+CO₂ (8)

Therefore, by repeatedly carrying out the contacting step and the heating step, it is possible to efficiently generate hydrogen as a whole. As a way for further enhance the efficiency, it is possible to think of preparing a plurality of reactor beds, generating hydrogen while adsorbing carbon dioxide with some of them, and discharging the carbon dioxide by heating the rest of them. In such away, however, not only a plurality of reactor beds are required, but also a plurality of heating apparatuses are required to regenerate the carbon dioxide adsorption capacity of the carbon dioxide adsorbent. Accordingly, the entire hydrogen generation apparatus has become large-scale and expensive.

Hence, the heating step can preferably carried out in a period of time as short as possible. Therefore, it is preferable to avoid heating the reactor bed, which is put in a reactor, from outside the reactor, and to directly heat the reactor bed. When the reactor bed is thus heated directly, since the heat capacity of the reactor bed itself is small, it is possible to heat the reactor bed to a carbon dioxide desorption temperature in a short period of time. Then, when the heating is turned off and the mixture gas is circulated, since the reaction set forth in equation (1) is an endothermic reaction, it is possible to rapidly cool the reactor bed by the development of the reaction. Thus, it becomes possible to quickly absorb the carbon dioxide.

In order to heat the reactor bed in a short period of time as set forth above, it is preferable to use a method by means of a high temperature gas or a method by means of electromagnetism.

As an example of the former method, it is possible to think of heating the mixture gas by disposing a heater in the flow of the mixture gas, which is supplied to the reactor bed. However, since it is difficult to absorb the carbon dioxide during the heating, CO co-generates at the reactor bed when the mixture gas is supplied to the reactor bed. Therefore, it is preferable to supply the other gas, such as steam, air, an inert gas, etc., to the reactor bed.

Above all, it is preferable to supply air in an amount, which is sufficient to completely combust the fuel included in the mixture gas, to combust the fuel by means of a catalytic action of a noble metal of the reforming catalyst, which is included in the reactor bed, and to heat the reactor bed by the resulting combustion heat. With such an arrangement, since the fuel is combusted adjacent to the carbon dioxide adsorbent, it is possible to most efficiently utilize the generated heat for heating the carbon dioxide adsorbent. As a result, the carbon dioxide adsorbent can be regenerated very quickly. Note that, when the fuel is combusted completely, the generation of CO and methane is none at all theoretically, and gases discharged from the reactor bed include only a nitrogen gas, a carbon dioxide gas and steam. Accordingly, when the discharged gases are supplied to fuel cells, they extremely less adversely affect fuel cells. Moreover, in order to control the generated heat quantity in the reactor bed, it is necessary to appropriately control a supply amount of the mixture gas. Note that, however, when the supply amount of the mixture gas is determined, it is possible to explicitly determine the amount of air required for completely combusting the fuel from the amount of the fuel included in the mixture gas.

When the air or oxygen rich gas is supplied in an amount insufficient for completely combusting the fuel, it is not preferred because there occur the deposition of carbon and the generation of CO. When the air or oxygen rich gas is supplied excessively, it is not preferred because oxygen and nitrogen are mingled in the resulting hydrogen in the subsequent contacting step. For example, let us consider a case where the generated hydrogen is used for fuel cells. When the amount of oxygen theoretically required for completely combusting the fuel is regarded as 1, a ratio of the supply amount of oxygen with respect to the theoretical amount can preferably fall in a range of from 0.9 to 1.2, further preferably in a range of from 0.97 to 1.1. Even if the supply amount of oxygen is less than 1, CO and CH₄ are little generated in the aforementioned range when steam coexists. Moreover, even if the supply amount of oxygen exceeds 1 but falls in the aforementioned range, the excessive oxygen can be utilized to oxidize and remove carbon and sludge, which generate in the contacting step.

Further, in the heating step in which the fuel and oxygen are reacted, since it is possible to directly heat the carbon dioxide adsorbent without heating the entire reactor bed, it is possible to more efficiently decompose carbonates. Furthermore, since the entire reactor bed is not heated to a high temperature, it is possible to quickly switch to the subsequently following contacting step.

Moreover, as for the latter method employing electromagnetism, it is possible to exemplify a heating method in which a structural member, constituting the reactor bed, is made from a conductor member and electricity is supplied to the structural member, a heating method in which an electromagnetic wave is irradiated to the reactor bed, a heating method by means of induction heating or dielectric heating, and so on. In this case as well, CO co-generates at the reactor bed when the mixture gas is supplied to the reactor bed. Therefore, it is preferable to supply the other gas, such as steam, air, an inert gas, etc., to the reactor bed.

Note that it is also preferable to simultaneously use the heating method with a high temperature gas and the heating method by means of electromagnetism. For instance, the mixture gas and air, which is sufficient for completely combusting the fuel included in the mixture gas, can be supplied while directly heating the reactor bed by means of electromagnetism. With such an arrangement, it is possible to spontaneously heat the reactor bed by the heating by means of electromagnetism as well as by the heating with the combustion heat, and accordingly to quickly regenerate the carbon dioxide adsorbent. This method is particularly effective when the temperature of the reactor bed is low in the generation of hydrogen.

The contacting step and the heating step can be carried out alternately in succession. Further, in the heating step, it is possible to turn off or reduce the supply of the steam. Furthermore, it is preferable to vary the supply amounts of the fuel in the contacting step and the heating step, respectively. When the amount of the supplied fuel is large and the air is supplied in an amount required for combusting the fuel, the generated heat quantity is so enlarged that the reactor bed is heated to an elevated temperature. Accordingly, there might arise a fear of degrading the reforming catalyst. Therefore, in the heating step, it is preferable to supply the fuel in such an amount that it generates heat necessary and sufficient for decomposing the generated carbonates, and to supply the air in an amount necessary and sufficient for combusting the fuel. With such an arrangement, it is possible to inhibit the reforming catalyst from degrading by controlling the generating heat quantity. Thus, it is possible to reduce the fuel usage amount.

As set forth above, it is possible to extremely quickly carry out the regeneration of the carbon dioxide adsorbent by supplying the oxygen or air. Therefore, when the contacting step and the heating step are carried out alternately, it is possible to reduce the time for the heating step to about a few seconds, and to extend the time for the contacting step. Thus, it is possible to efficiently generate hydrogen.

A ratio of the time for the contacting step to the time for the heating step depends on specific purposes. However, it is preferable to adjust the interval between the start of the contacting step and the completion thereof so as to fall in a range of 70% or less of the time required for saturating the carbon dioxide adsorption capacity of the carbon dioxide adsorbent. This is because the carbon dioxide adsorption rate of the carbon dioxide adsorbent lowers as the carbon dioxide adsorption capacity thereof saturates. Moreover, even within the aforementioned time range, the temperature of the catalyst bed decreases gradually because the contacting step is an endothermic reaction. When the temperature of the catalyst bed decreases, the reaction rate lowers. Thus, the generation efficiency of hydrogen degrades so that not-reacted organic substances mingle in the generated hydrogen. Therefore, before such a drawback arises, it is necessary to switch the contacting step to the heating step, and to carry out the heating step at 300° C. or more, further preferably at 500° C. or more.

The heating step can be carried out for a time period sufficient for decomposing the carbonates and desorbing the carbon dioxide. When the heating step is carried out longer than the time period, the fuel is eventually consumed wastefully in a case where oxygen is added to the fuel gas. Therefore, it is preferable to switch the contacting step and the heating step with a shorter cycle. However, the switching of an extraordinary frequency is not preferred because it causes a partial oxidation state to generate CO. Accordingly, it is practical that the switching cycle can preferably fall in a range of from 1 second to 10 minutes.

The mixture gas is constituted by the fuel, which includes a carbon compound at least, and the steam. As for the fuel, it is possible to use a simple substance of a variety of hydrocarbons or mixtures thereof. The steam is mixed with the fuel in an amount conforming to the amount of the fuel. For example, when the present invention is applied to the supply of hydrogen to automotive fuel cells, it is preferred that an automotive fuel, such as gasoline, methanol, etc., is mixed with the steam to use. With such an arrangement, it is possible to use an automotive fuel in the contacting step as well as in the heating step. Accordingly, it is not necessary to turn off the fuel supply. Moreover, it is possible to alternately carry out the contacting step and the heating step in one reactor with ease.

As for the reforming catalyst, it is possible to use an Fe—Cr-based catalyst, a Cu—Zn-based catalyst, Ni, Co, and so on, which have been used conventionally. However, there might arise a case where the conventional catalysts lose the activities by oxidation or hydrolysis in the heating step. Accordingly, it is preferable to use a noble metal, which is not readily oxidized. For example, when using the fuel including an organic compound such as hydrocarbon and alcohol, it is preferable to use at least one member selected from the group consisting of Rh and Ru in the steam reforming reaction set forth in equation (1). In the steam reforming reaction, when Pt is used in addition to Rh, if the amount of Pt is relatively larger than that of Rh, it is apparent that the progress of the steam reforming reaction is prevented. Therefore, if Pt is included, it is preferable that small amount of Pt is included. No amount of Pt can be included. While, when using the fuel including CO, the CO shift reaction is equations (2), hence it is preferable to use at least one member selected from the group consisting of Pt and Pd. It is more preferable to use Pt, and Rh is not essential. Therefore, it is preferable to use at least one member selected from the group consisting of Rh and Ru and at least one member selected from the group consisting of Pt and Pd.

The reforming catalyst can be formed so that a noble metal is loaded on a porous oxide support substance, being made from a mixture, a compound, or the like, which is composed of at least one species selected from the group consisting of Al₂O₃, CeO₂, ZrO₂, TiO₂, SiO₂, SiO₂-Al₂O₃, MgAl₂O₄, and the like, or in which two or more species thereof are combined. Among them, a reforming catalyst is an optimum option in which a noble metal is loaded on MgAl₂O₄ or ZrO₂.

In the reforming catalyst, it is believed that H₂O is activated by the basic hydroxide groups of the porous oxide support and HC is activated by the noble metal. Hence, the steam reforming reaction proceeds smoothly. Note that the loading amount of the noble metal is not limited in particular. However, the loading amount can preferably fall in a range of from 0.008 to 4.0 parts by weight with respect to 100 parts by weight of the porous oxide support.

As for the carbon dioxide adsorbent, it is appropriate to use a material, which includes at least one member selected from the group consisting of alkali metals and alkaline-earth metals. These components can absorb and hold carbon dioxide therein in a form of the carbonates. Moreover, these components can preferably be formed so that they are held in an inorganic porous support. This is because the alkali metals or alkaline-earth metals undergo a large volumetric variation in the transformation from the carbonates to the oxides or vice versa so that it is difficult for them to independently make a stable structural member. Note that it is preferable to use the alkali metals or alkaline-earth metals whose carbonates exhibit a decomposition temperature of 500° C. or more so that the carbonates are stable. Accordingly, it is recommendable to use oxides of the alkaline-earth metals, such as magnesium, calcium, strontium, and so on. Alternatively, it is recommendable to use oxides of the alkali metals, such as sodium, potassium, lithium, and so on.

The inorganic porous substance can preferably be less likely to interact with the alkali metals and alkaline-earth metals. For instance, Al₂O₃ and SiO₂ react with the alkali metals and alkaline earth metals at an elevated temperature so that they gradually lose the carbon dioxide adsorption action. Therefore, the inorganic porous substance can preferably a substance, which does not react with the carbon dioxide adsorbent, or which helps the carbon dioxide adsorbent to recover the carbon dioxide adsorption capacity in the presence of a carbon dioxide gas with ease even if it reacts with the carbon dioxide adsorbent. Moreover, the inorganic porous substance can preferably exhibit a heat resistance so that it does not change in quality by heating in the heating step. As for such an inorganic porous support, it is preferable to use a substance, which includes MgAl₂O₄, ZrO₂, or the like, as a principal ingredient.

The reactor bed can be formed by mixing the reforming catalyst and carbon dioxide adsorbent. Alternatively, it is possible to use a reactor bed in which the noble metal and carbon dioxide adsorbent are loaded on a common porous oxide support. Note that the configuration of the reactor bed is not limited in particular. It is possible to make a surface of a pellet-shaped structural member into a reactor bed. Optionally, it is preferable to form a reactor bed on a surface of a honeycomb-shaped monolithic substrate by coating.

Moreover, the reforming catalyst and the carbon dioxide adsorbent are disposed as close as possible. For example, they can preferably be uniformly dispersed and mixed as particles, whose particle diameter is 30 nm or less, in the reactor bed. It is possible to carry out disposing the reforming catalyst and carbon dioxide adsorbent in such a manner with ease by preparing aqueous solutions of the reforming catalyst and carbon dioxide adsorbent, respectively, and loading them on an inorganic porous substance.

While, an apparatus for generating hydrogen comprises: a reactor bed including a reforming catalyst and a carbon dioxide adsorbent; source gas supplying means for supplying a mixture gas, comprising a fuel and steam, the fuel including a carbon compound at least, to the reactor bed; heating means for heating the reactor bed; and temperature controlling means for controlling temperatures of the reactor bed in a contacting step and a heating step, respectively, while carrying out the contacting step, in which the mixture gas is contacted with the reactor bed, thereby converting the mixture gas into hydrogen by means of a steam reforming reaction with the reforming catalyst and adsorbing co-generating carbon dioxide onto the carbon dioxide adsorbent, and the heating step, in which the reactor bed is heated, thereby desorbing the adsorbed carbon dioxide from the carbon dioxide adsorbent and regenerating a carbon dioxide adsorption capacity of the carbon dioxide adsorbent.

The reforming catalyst, the carbon dioxide adsorbent, the reactor bed, the fuel, the mixture gas, the heating means, the contacting step and the heating step are the same as those exemplified in the present hydrogen generation process. As far as the source gas supplying means can vaporize the water and fuel, respectively, and supply them to the reactor bed, the source gas supplying means is not limited in particular.

The temperature controlling means controls the temperatures of the reactor bed in the contacting step and heating step, respectively, by detecting the temperatures of the reactor bed and controlling the heating means and source gas supplying means in accordance with the detected temperatures.

The present hydrogen generation apparatus can preferably further comprises combustion gas supplying means for supplying a combustion gas, comprising the fuel and oxygen, to the reactor bed, and switching means for alternately switching the supplies from the source gas supplying means and the combustion gas supplying means, wherein the heating means heats the reactor bed by combusting the combustion gas. With such an extra arrangement, as described in the present hydrogen generation process, the fuel can be combusted adjacent to the carbon dioxide adsorbent. Accordingly, it is possible to most efficiently utilize the generated heat to heat the carbon dioxide adsorbent. As a result, it is possible to extremely quickly regenerate the carbon dioxide adsorption capacity of the carbon dioxide adsorbent.

The combustion gas supplying means can supply a gas, such as air, etc., which includes oxygen, to a fuel, from which steam is excluded. Alternatively, the combustion gas supplying means can supply a gas, which includes oxygen, to a mixture gas, which includes steam.

Moreover, the present hydrogen generation apparatus can preferably further have means for supplying an exhaust gas, which is emitted from a reactor in the heating step, back to the reactor from the outside. With such an extra arrangement, it is possible to indirectly heat the reactor bed by the heat of the exhaust gas. Accordingly, it is possible to further quicken the temperature increment of the reactor bed. Thus, it is possible to shorten the time required for the heating step.

The present invention will be hereinafter described in detail with reference to examples and comparative examples.

FIG. 2 illustrates a constitution of a hydrogen generation apparatus, which was used in examples according to the present invention. The hydrogen generation apparatus was constituted mainly by a vaporizer 2, a reactor 3 and an intermittent injector 4. The vaporizer 2 heated hydrocarbons and water, which were supplied from the outside, to vaporize them under a pressure application, and supplied the generating mixture gas, which was held at a predetermined temperature, to the reactor 3. The intermittent injector 4 was actuated by a pulse timing generator 40, and supplied air intermittently to the reactor 4 when the flow rate of the mixture gas, which was supplied from the vaporizer 2 to the reactor 3, reached to a predetermined flow rate.

In the reactor 3, there was disposed a reactor bed. In a contacting step, the mixture gas, which was supplied from the vaporizer 2, was reformed on the reactor bed to generate H₂. At the same time, co-generating carbon dioxide was adsorbed onto a carbon dioxide adsorbent in the reactor bed.

When the mixture gas was supplied in such an amount that 70% of the carbon dioxide adsorbent was turned into the carbonate, the contacting step was switched to a heating step. The pulse timing generator 40 was operated to actuate the intermittent injector 4. Accordingly, air was supplied to the vaporizer 2 in a predetermined flow rate. At the same time, the flow rate of the mixture gas was controlled in order to control the generated heat quantity. Namely, a gas, in which air was mixed in an amount required for completely combusting the hydrocarbons included in the mixture gas, was supplied to the reactor 3.

In the reactor 3, the fuel gas was combusted by oxygen included in the air through a catalytic action of a noble metal, which was loaded on the reactor bed. The carbonate, which had been converted from the carbon dioxide adsorbent of the reactor bed, was heated by the resulting heat generation. Thus, the carbonate was decomposed, and thereby the carbon dioxide adsorbent was converted back into an oxide to regenerate the carbon dioxide adsorption capacity. Note that an exhaust gas, which was emitted from the reactor 3, was discharged through a flow passage, which was different from a flow passage used in the contacting step. After the entire carbon dioxide adsorbent was regenerated, the intermittent injector 4 was turned off. Then, the contacting step was again carried out.

While, alumina-magnesia spinel (MgAl₂O₄) was coated on a honeycomb-shaped substrate, which was made from corrdierite, in an amount of 240 g with respect to 1 L of the honeycomb-shaped substrate. Further, Pt and Rh were loaded on the honeycomb-shaped substrate by using their aqueous solutions in such amounts that the Pt and Rh were loaded in amounts of 0.1 g and 2 g, respectively, with respect 1 L of the honeycomb-shaped substrate. Furthermore, after the honeycomb-shaped substrate was calcined at 400° C., Ca was loaded on the honeycomb-shaped substrate by using a calcium nitrate aqueous solution in such amount that the Ca was loaded in an amount of 0.3 mol with respect to 1 L of the honeycomb-shaped substrate. Finally, the honeycomb-shaped substrate was calcined at 500° C. Thus, a reactor bed was formed in which a reforming catalyst and a carbon dioxide adsorbent were included on the surface of the honeycomb-shaped substrate. In the following comparative examples and examples, the honeycomb-shaped substrate was used which was provided with the reactor bed.

### COMPARATIVE EXAMPLE NO. 1

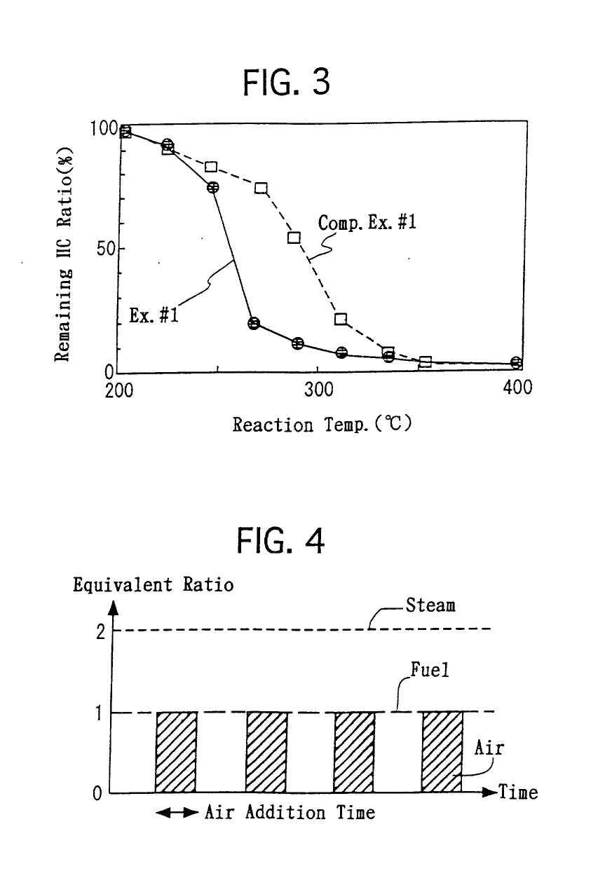

The honeycomb-shaped substrate, which was provided with the reactor bed, was disposed in the reactor 3. Propylene (i.e., the fuel) and steam were supplied under such a condition that a ratio of the number of moles of the steam with respect to the number of the carbon atoms (hereinafter referred to as a “molar H₂O/C ratio”) was controlled at 2.5. The propylene and steam underwent a reforming reaction at respective temperatures falling in a range of from 200 to 400° C. At the outlet of the reactor 3, the HC contents in the outlet gas were measured to calculate the remaining HC ratios. Note that, in Comparative Example No. 1, the intermittent injector 4 was turned off. FIG. 3 illustrates the results.

### EXAMPLE NO. 1

The honeycomb-shaped substrate, which was provided with the reactor bed, was disposed in the reactor 3. A contacting step was carried out in which propylene and steam were supplied for 10 seconds under the condition that the molar H₂O/C ratio was controlled at 2.5. Thereafter, the intermittent injector 4 was actuated, and a heating step was carried out in which air was supplied for 10 seconds in an equivalent amount for completely combusting the propylene. While the contacting step and the heating step were repeated alternately, at the outlet of the reactor 3, the HC contents in the outlet gas were measured to calculate the remaining HC ratios at respective temperatures. The measurement was carried out at temperatures falling in a range of from 200 to 400° C. FIG. 3 illustrates the results.

### Evaluation

FIG. 3 illustrates that the lower the remaining HC ratio was the further the fuel reforming reaction proceeded. Therefore, Example No. 1 was better than Comparative Example No. 1 in terms of the reactivity in a low temperature range. For instance, by comparing Example No. 1 with Comparative Example No. 1 at a time when the propylene was reacted by about 50%, it is understood that the reaction temperature was lower by 50° C. approximately in Example No. 1 than in Comparative Example No. 1. Namely, it is apparent that the heating step, in which the air was supplied for 10 seconds, enabled the fuel reforming reaction to take place at a lower temperature.

Moreover, the fuel reforming reaction was closely observed at reaction temperatures around 450° C. As a result, the following were found out. In the hydrogen generation process of Example No. 1, the existence of CO₂ was not confirmed until the air was supplied. However, immediately after the air was supplied, CO₂ was generated. The phenomena imply the following. The steam reforming reaction and the CO shift reaction proceeded until the air was supplied. The generated CO₂ was quickly adsorbed by CaO. The propylene was combusted by the air supply. The resulting heat decomposed CaCO₃ to generate CO₂. Namely, in accordance with the hydrogen generation process of Example No. 1, the resulting reformed fuel gas was mostly composed of H₂.

On the contrary, in the hydrogen generation process of Comparative Example No. 1, the generation of CO₂ was not confirmed initially. However, after a few dozens of seconds passed, CO₂ was generated in a large volume, and the generation of methane resulting from the generation of CO₂ was confirmed as well.

### EXAMPLE NO. 2

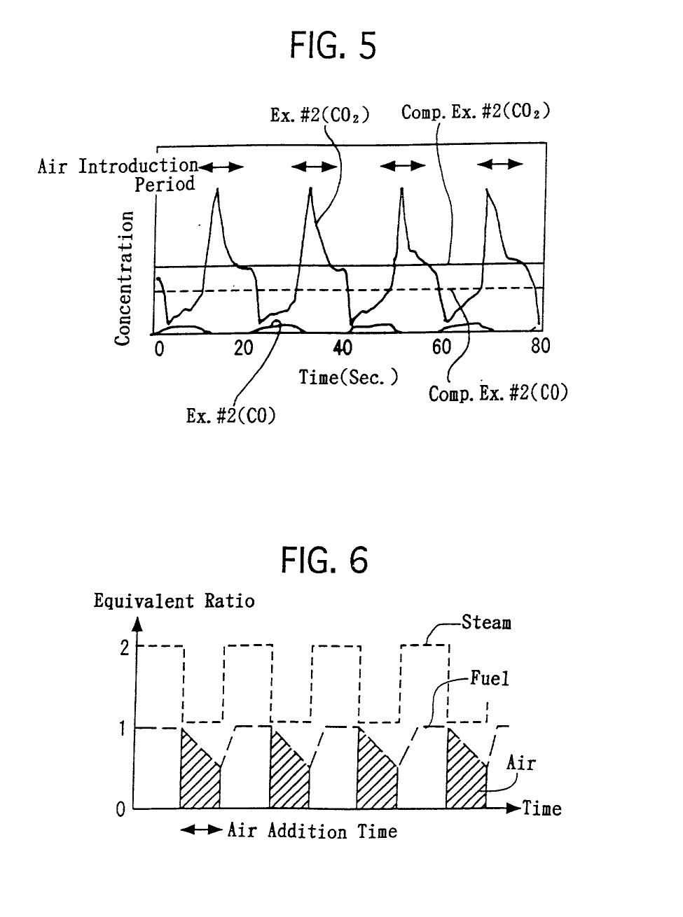

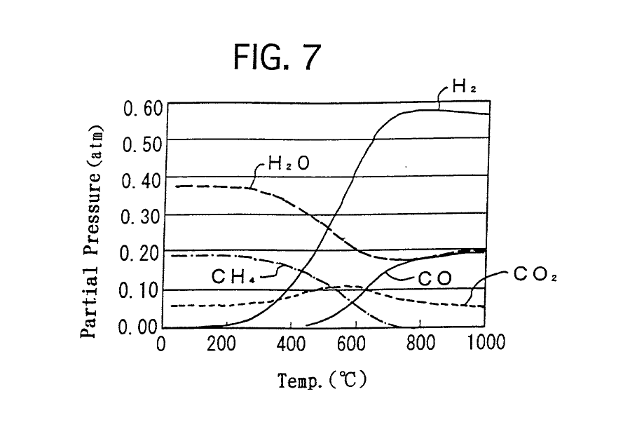

The honeycomb-shaped substrate, which was provided with the reactor bed, was disposed in the reactor 3. As illustrate in FIG. 4, the following operations were repeated at 350° C. alternately. Specifically, propylene and steam were supplied for 10 seconds under the condition that the molar H₂O/C ratio was controlled at 2.0. Thereafter, in addition to the propylene and steam, air was supplied for 10 seconds in an equivalent amount for completely combusting the propylene. At the outlet of the reactor 3, the CO concentrations and CO₂ concentrations in the outlet gas were measured continuously. FIG. 5 illustrates the results.

### COMPARATIVE EXAMPLE NO. 2

The honeycomb-shaped substrate, which was provided with the reactor bed, was disposed in the reactor 3. Propylene and steam were supplied for 10 seconds under the condition that the molar H₂O/C ratio was controlled at 2.0, and were reacted at 350° C. At the outlet of the reactor 3, the CO concentrations and CO₂ concentrations in the outlet gas were measured continuously. Note that, in Comparative Example No. 2, the intermittent injector 4 was turned off. FIG. 5 illustrates the results.

### Evaluation

As can be seen from FIG. 5, in the hydrogen generation process of Comparative Example No. 2, CO and CO₂ were generated constantly in relatively high concentrations. On the other hand, in the hydrogen generation process of Example No. 2, CO was generated in the periods when the air was not supplied, but the volume was extremely less than that in Comparative Example No. 2. Moreover, immediately after the air was supplied, CO₂ was generated. When the air supply was turned off, the CO₂ concentration was decreased greatly, and was thereafter increased gradually. These phenomena imply that, in the contacting step, CO₂ was adsorbed by CaO, and that, in the heating step, CO₂ was generated by the decomposition of CaCO₃.

### EXAMPLE NO. 3

In the above-described hydrogen generation process of Example No. 2, the supplying amounts of the propylene and steam were constant. However, when carrying out the heating step, it is not necessary to supply the steam. Moreover, in the heating step, the propylene can be supplied sufficiently in such an amount that only a heat quantity, which enables CaCO₃ to decompose, is provided. Accordingly, it is possible to reduce the propylene supply amount less in the heating step than that in contacting step.

Hence, in Example No. 3, the steam and fuel were supplied as illustrated in FIG. 6. Specifically, the steam supply amount was reduced by half when the air was supplied. The fuel supply amount was reduced gradually as the time periods of the air supply elapsed, and was reduced by half at 10 minutes after the air supply started.

Therefore, in accordance with the hydrogen generation process of Example No. 3, it was possible to reduce the usage amounts of the steam and fuel while acquiring the same advantages as those of Example No. 2. Thus, it was possible to generate H₂ less expensively. Moreover, since the fuel supply amount was reduced in the heating step, the generating heat quantity was reduced as well. Consequently, it was possible to further inhibit the reforming catalyst from degrading.

Note that, when the air is supplied, it is preferable to abruptly supply the air in a rectangularly pulsating manner as described in Example No. 2 or 3. When the air is supplied in a pulsating manner like a sawtooth shape, the partial oxidation reaction (i.e., HC+O₂→CO+H₂) is facilitated, and is adversely resulted in the enlargement of the CO generation.

Having now fully described the present invention, it will be apparent to one of ordinary skill in the art that many changes and modifications can be made thereto without departing from the spirit or scope of the present invention as set forth herein including the appended claims.

What is claimed is:

1. A process for generating hydrogen, comprising the steps of:
contacting a mixture gas, comprising a fuel and steam, the fuel including a carbon compound at least, with a reactor bed, comprising a reforming catalyst and a carbon dioxide adsorbent, thereby converting the mixture gas into hydrogen and adsorbing co-generating carbon dioxide onto the carbon dioxide adsorbent; and
heating the reactor bed, thereby desorbing the adsorbed carbon dioxide from the carbon dioxide adsorbent and regenerating a carbon dioxide adsorption capacity of the carbon dioxide adsorbent.

2. The process according to claim 1, wherein said heating step is carried out by directly heating the reactor bed.

3. The process according to claim 2, wherein said heating step is carried out by heating with a high temperature gas.

4. The process according to claim 3, wherein the high temperature gas is prepared by completely combusting a combustion gas in which at least the fuel and oxygen are mixed.

5. The process according to claim 2, wherein said heating step is carried out by rapidly heating by means of electromagnetism.

6. The process according to claim 1, wherein, when the fuel includes an organic compound, the reforming catalyst includes at least one member selected from the group consisting of Rh and Ru.

7. The process according to claim 1, wherein, when the fuel includes CO, the reforming catalyst includes at least one member selected from the group consisting of Pt and Pd.

8. The process according to claim 1, wherein the carbon dioxide adsorbent includes at least one member selected from the group consisting of alkali metals and alkaline-earth metals.

9. The process according to claim 1, wherein the reforming catalyst and the carbon dioxide adsorbent are dispersed and mixed at a level of 30 nm or less.

10. The process according to claim 4, wherein the high temperature gas, which is prepared by combusting the combustion gas by means of a catalytic reaction in the reactor bed, is used in said heating step.

11. An apparatus for generating hydrogen, comprising:
a reactor bed including a reforming catalyst and a carbon dioxide adsorbent;
source gas supplying means for supplying a mixture gas, comprising a fuel and steam, the fuel including a carbon compound at least, to said reactor bed;
heating means for heating said reactor bed; and
temperature controlling means for controlling temperatures of said reactor bed in a contacting step and a heating step, respectively, while carrying out the contacting step, in which the mixture gas is contacted with said reactor bed, thereby converting the mixture gas into hydrogen by means of a steam reforming reaction with the reforming catalyst and adsorbing co-generating carbon dioxide onto the carbon dioxide adsorbent, and the heating step, in which said reactor bed is heated, thereby desorbing the adsorbed carbon dioxide from the carbon dioxide adsorbent and regenerating a carbon dioxide adsorption capacity of the carbon dioxide adsorbent.

12. The apparatus according to claim 11 further comprising combustion gas supplying means for supplying a combustion gas, comprising the fuel and oxygen, to said reactor bed, and switching means for alternately switching the supplies from said source gas supplying means and the combustion gas supplying means, wherein said heating means heats said reactor bed by combusting the combustion gas.
